(19) United States
(12) Patent Application Publication
(10) Pub. No.: US 2017/0200124 A1
(43) Pub. Date: Jul. 13, 2017

(54) SIGN ME

(71) Applicant: Clayton Goodman, Tarzana, CA (US)

(72) Inventor: Clayton Goodman, Tarzana, CA (US)

(21) Appl. No.: 14/733,032

(22) Filed: Jan. 11, 2016

(51) Int. Cl. G06Q 10/10; G06Q 10/06; G06F 17/30

(52) U.S. Cl. CPC G06Q 10/1053; G06F 17/30386; G06Q 10/06398; G06Q 10/063112

(57) ABSTRACT

A mobile device application, which matches actors with prospective talent representatives, including casting directors. Matches are made on a identical question and answer basis. It will provide each talent representative with a better fit actor for the position in which they are trying to fill. The application will also include a rating system that can only be completed by the talent representative or sign me admin. Sign Me puts both parties on the same page. actors put in their physical characteristics and qualifications, which is matched with current talent agencies requirements for roles. This will also benefit casting directors through the use of talent ratings, where primarily those with good reviews will appear as a match for their requirement.

### FIELD OF THE INVENTION

The invention is a method and apparatus for enabling users to match talent with prospective talent representatives, including casting directors. Matches are made on identical question and answer basis. It will provide each talent representative with a better fit actor for the position in which they are trying to fill. The application will also include a rating system that can only be completed by the talent representative or an administrator of the admin.

### BACKGROUND OF THE INVENTION

Problem Solved: The problem actors and models have is finding legitimate agency or management firm representation when submitting for production projects. Managers, Agents, and Casting Directors have a similar problem when it comes to filling a role. Suitable talent or representation is incredibly difficult to find without spending hours filtering through thousands of options, many of which may not be qualified, based on role requirements. Time and money is wasted on a daily basis going through this search process.

Actors and models currently have to mail/email their head shots and resumes to countless Agents, hoping they will have the right qualifications that will make their investment worth while. This often is not the case and a lot of time and money is wasted with this existing method.

Sign Me puts both parties on the same page. actors put in their physical characteristics and qualifications, which is matched with current talent agencies requirements for roles. This will also benefit casting directors through the use of talent ratings, where primarily those with good reviews will appear as a match for their requirement.

### SUMMARY OF THE INVENTION

As stated above, the problem actors and models have is finding legitimate agency or management firm representation when submitting for production projects. Managers, Agents, and Casting Directors have a similar problem when it comes to filling a role. Suitable talent or representation is incredibly difficult to find without spending hours filtering through thousands of options, many of which may not be qualified, based on role requirements. Time and money is wasted on a daily basis going through this search process. The invention claimed here solves this problem.

Throughout this disclosure the terminology “Sign Me” is used to refer to the invention. Sign Me is an app that matches actors and models with Talent Managers, Agencies, and Casting Directors, using a match requirement. With detailed and specific questions, as well as a rating system allowing representatives to rate talent, Sign Me will immediately identify only the most appropriate actors and representatives for each role.

### BRIEF DESCRIPTION OF THE SEVERAL VIEWS OF THE DRAWINGS

FIG. 1 represents a first screen providing a starting interface that enables a user to interact with a computer application embodying the invention.

FIG. 2 represents a screen providing a selection for a user to use the application as an talent or as an agent to interact with a computer application embodying the invention.

FIG. 3 represents a screen for authenticating a user as an actor using a computer application embodying the invention.

FIG. 4 represents a screen for capturing user actor basic information using a computer application embodying the invention.

FIG. 5 represents a screen for capturing user actor detailed information using a computer application embodying the invention.

FIG. 6 represents a screen for enabling a user actor to access cost information using a computer application embodying the invention.

FIG. 7 represents a screen for providing usage help to a user using a computer application embodying the invention.

FIG. 8 represents a screen for capturing user agent basic information using a computer application embodying the invention.

FIG. 9 represents a screen for capturing user agent search information for searching for talent using a computer application embodying the invention.

FIG. 10 represents a screen for capturing user agent search information for further entering additional criteria for searching for talent using a computer application embodying the invention.

### DETAILED DESCRIPTION OF THE INVENTION

The claimed invention differs from what currently exists. It's the only mobile device App that matches talent (actors & models) with Agencies and Management Firms. It is also the only system that utilizes a rating system to differentiate prospective actors, thus holding those accountable for poor performance during a prior assignment.

This invention is an improvement on what currently exists. It's the only mobile device App that matches talent (actors & models) with Agencies and Management Firms. It is also the only system that utilizes a rating system to differentiate prospective actors, thus holding those accountable for poor performance during a prior assignment.

There is a lack of organization and communication to the application and hiring process. Many are just ambiguous postings on different websites, while others are group or private pages. It is often the case that prospective actors don't know if different agencies are hiring, what that agency may be looking for, or even the legitimacy of the agency. By Sign Me pre-screening each agency, actors and models can by confident in the validity of the agency they are getting involved with.

Talent firms are flooded with head shots and resumes of talent every day weather or not there hiring or looking for new talent. It is all disorganized and a huge cat and mouse game.

Sign Me puts both parties on the same page. actors put in their physical characteristics and qualifications, which is matched with current talent agencies requirements for roles. This will also benefit casting directors through the use of talent ratings, where primarily those with good reviews will appear as a match for their requirement.

### The Version of the Invention Discussed Here Includes

1. hit the app icon, then Logo appears

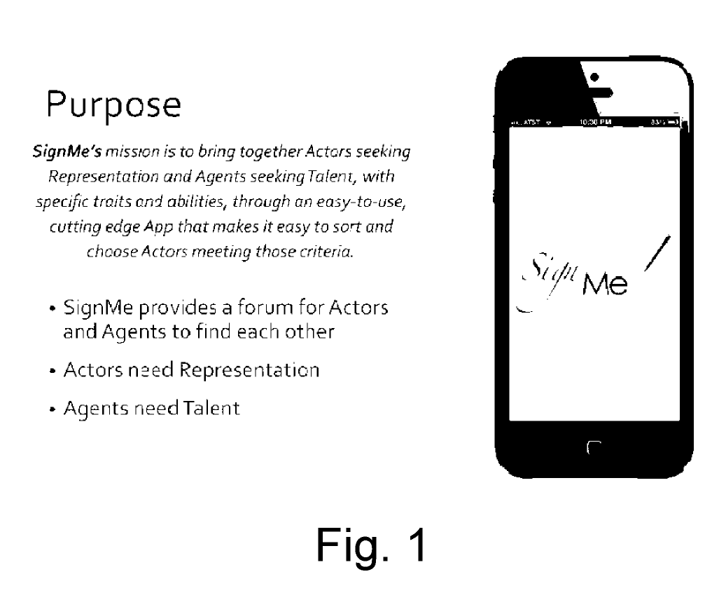

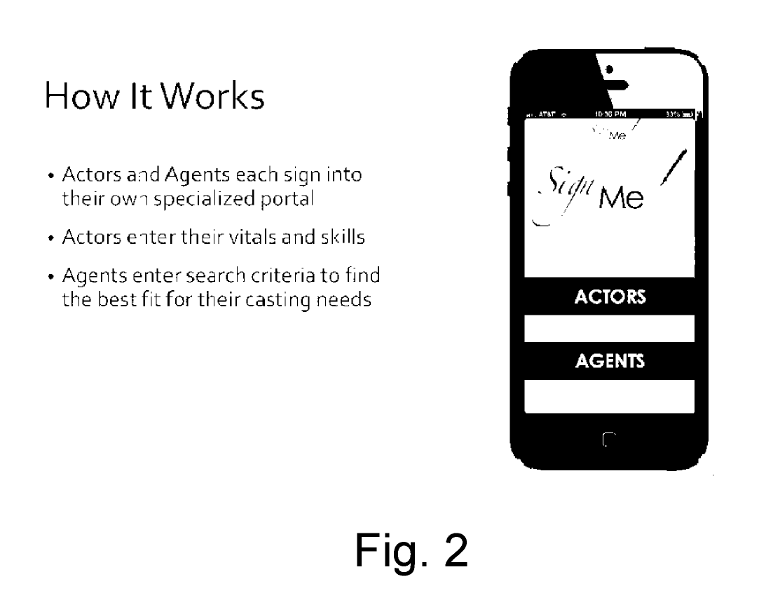

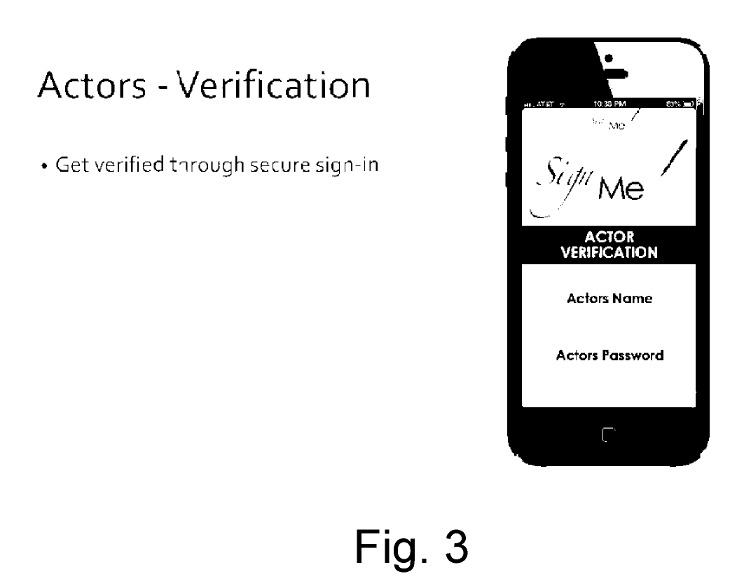

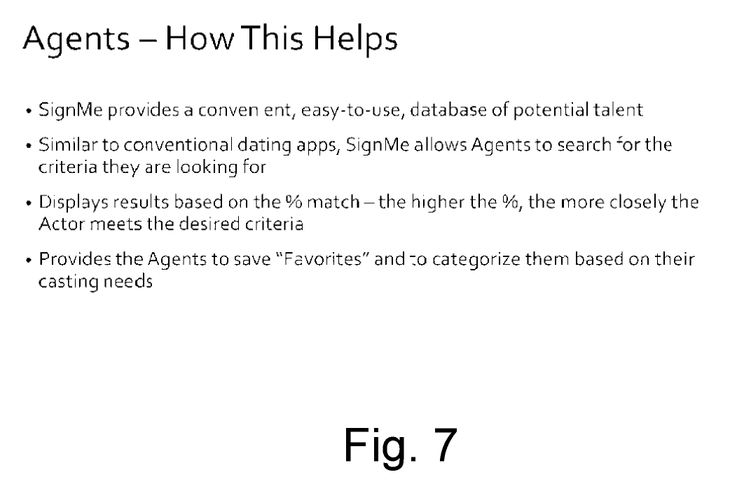

2. select which on you are for the actors/model, FIG. 1, FIG. 2, FIG. 3 and FIG. 7.

3. then select if you are—male—female—trans gender

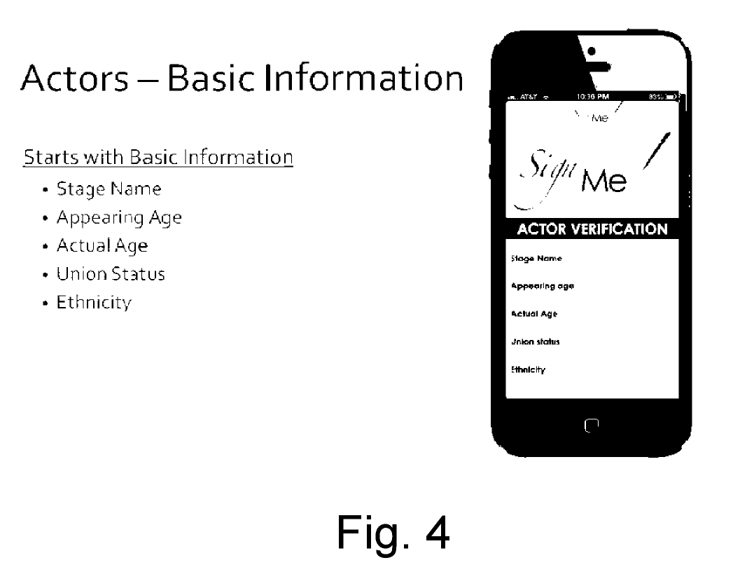

4. then—full appearance—male=height, weight, hair color, hair length, eyes, body type, facial hair, body hair, tattoos, piercings, hat size, glove size, shoe size, waist size, shirt size, coat size, in seam, glasses or contact, disabilities—explain what the disability is, FIG. 4 and FIG. 7.

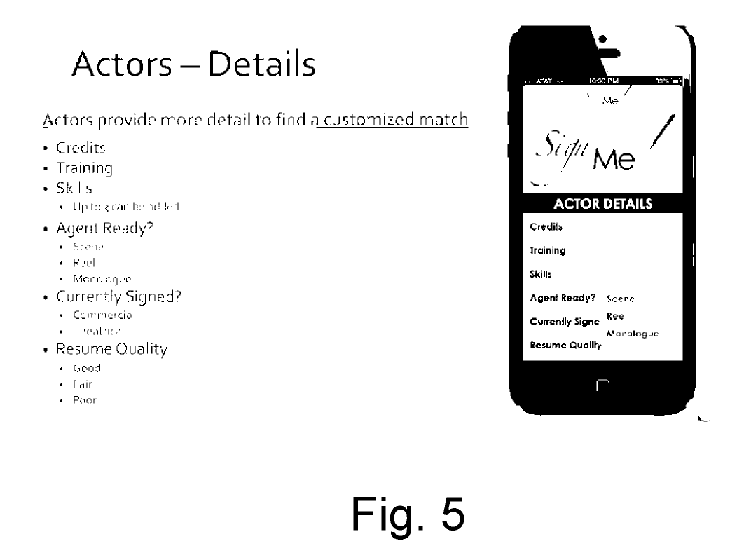

5. this is page 4 about you=credits skills list 3 uniqueness one thing any training—yes/no seeking—manager agent both currently signed yes/no seeking—commercial, theatrical, model representation ready—reel, monologue, scene, FIG. 5 and FIG. 7.

6. page 5 upload your resume and head shot

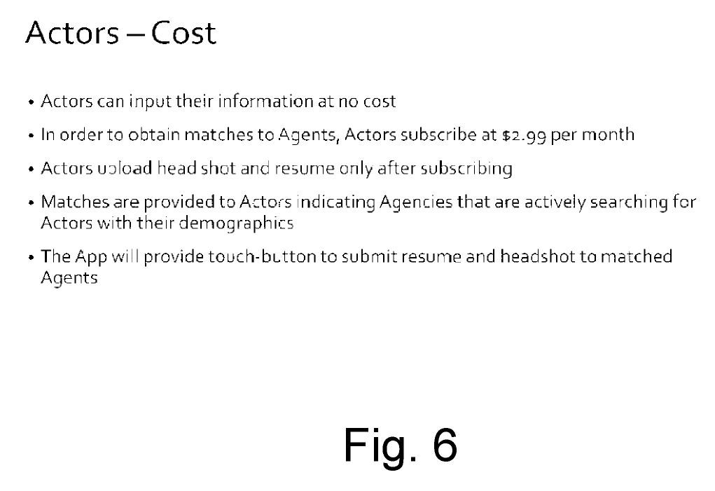

7. page 6 payment method submit then they will get there results, FIG. 6 and FIG. 7.

8. then they will also have an option for casting directors

9. after they choose casting directors they will have a rating giving buy the talent reps (agents, managers, casting directors) so it grades there level of experience for each job.

10. agents page login—name and password

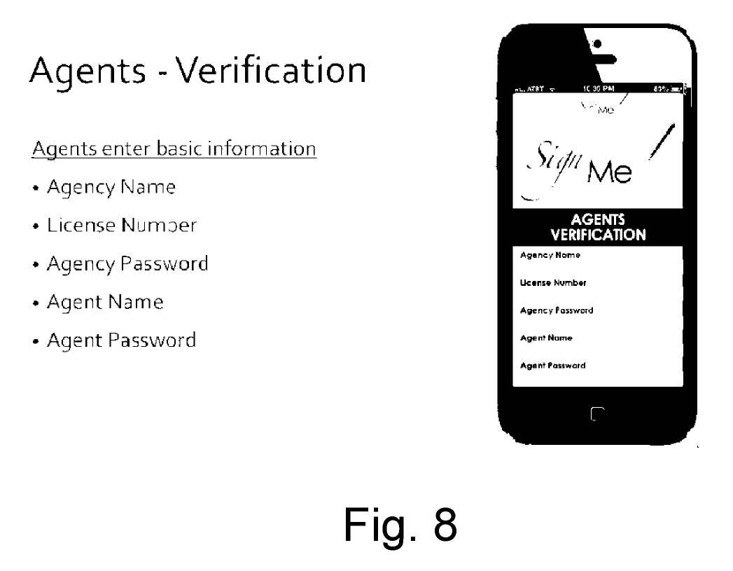

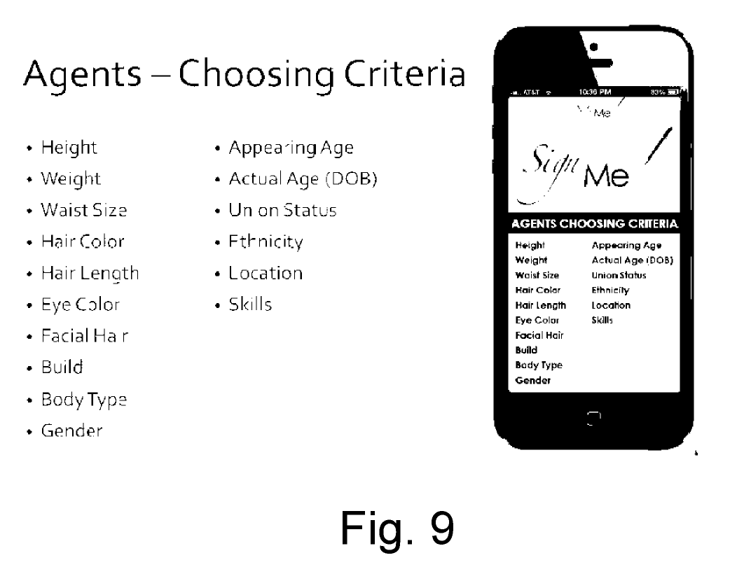

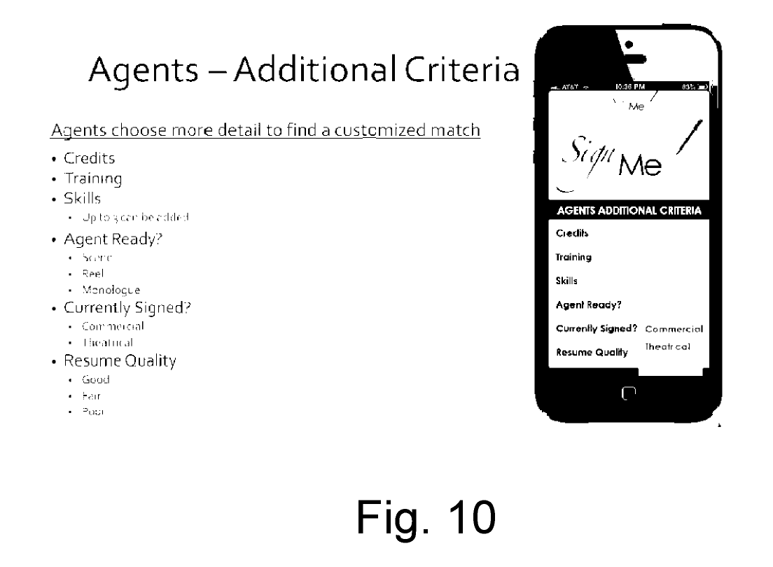

11. it should be the same but with a what are you looking for type question FIG. 8, FIG. 9 and FIG. 10.

### Relationship Between the Components

Each step is a question (primarily personal statistics) about the individual, in which the other party (Agent) would be concerned, as these are the traits required to fill a certain role.

page 1

actor, model, both [[â [symbol] ]]″ what are you looking to be represented as?

name—what would you like to be addressed by?

password—for page security

page 2

male—female—trans gender—provides necessary details to identify which roles you qualify for

race—tell the representation what ethnicity you are

age—what age you will be places in for search results

union status (non union, sage eligible, sag, sag aftra, aftra). â [symbol] ″ a partial matching question for representation to filter you through

page 3

full appearance—male=height, weight, hair color, hair length, eyes, body type, facial hair, body hair, tattoos, piercings, hat size, glove size, shoe size, waist size, shirt size, coat size, in seam, glasses or contact, disabilities—explain what the disability is—a partial matching question for representation to filter you through

page 3

full appearance—trans gender—male w female or female w male parts

height, weight, cup size, facial hair, hair color, hair length, eyes, body type, facial hair, body hair, tattoos, piercings, hat size, glove size, shoe size, bust size, waist size, shirt size, coat size, in seam, glasses or contact, disabilities—explain what the disability is—a partial matching question for representation to filter you through

page 4

about you—a partial matching question for representation to filter you through

credits—a partial matching question for representation to filter you through

skills list 3—a partial matching question for representation to filter you through

uniqueness one thing—a partial matching question for representation to filter you through

any training—yes/no—a partial matching question for representation to filter you through

seeking—manager agent both—a partial matching question for representation to filter you through

currently signed yes/no—a partial matching question for representation to filter you through

seeking—commercial, theatrical, model—a partial matching question for representation to filter you through

representation ready—reel, monologue, scene—a partial matching question for representation to filter you through

page 5

resume upload—The jobs you have had in the past to back up your training, in the desired field you chose in step 1

head shot upload—the photo you want to be placed in front of the representation to sway their choice with you.

page 6

payment method—how they are going to pay for the service, visa, MasterCard, American express

submit—this will show there matched results that correspond with the current representation looking.

then they will get there results “the number of potential talent representation and casting directors interested in them.

Scale rating how the actors or model is classified by the talent rep or the sign me admin.

### How the Invention Works

The purpose of making the Sign Me App (and any & all future updates) Is to unite actors with agents. If marketed the proper way, this will greatly expand the possibilities in the entertainment world.

Sign me app will help Agents find talent for their specific needs and help Talent acquire meetings with Agents.

Sign me app will help Agents/Manager and casting directors search the database of talent to narrow down to the specifics of what they need, i.e. union member, gender, height, age, etc. Among the most important features for Agents & Managers is the app only Agents who are currently accepting new talent, thus eliminating the occurrence of excessive applications while no positions are available. This can also be expanded into casting directors, sports world agents, and musicians. The potential for this app and the improvement it represents is limitless. The Sign me app membership is a minimal fee that provides actors with access they might never have had otherwise It will also feature a meetup point or station for other growing actors so they can have adequately rehearse with each other, that will allow actors to post up group meetings in a public place to rehears for lines with peers and it will range from begging actors to fully seasoned actors depending on the popularity of the app so others actors if choose to can meet other actors to rehears for jobs school or just sharp training, versus not doing it because you can't find anyone near your or that you know of wants to giving them open relationships to meet others and connect on a newly formed bases. With no download cost, even if the actor doesn't find an Agent/Manager immediately, the Sign me app will provide valuable advice as to how to grab the attention of the agencies/managers and will continue to provide future updates/advice. An upgrade to include Producers, Directors, and casting directors.

It is well worth the agent's time and the actor's time to use this app and expand their opportunities. Hollywood desperately needs this service to drastically improve their search methods. The app will take 300 resumes and headshots and reduce it down to 5 for the qualifying talent that fits the agent/managers needs and expectations. As an added feature, there will, there will also be a swipe function for Agents/Managers to swipe through talent head shots. It will make life easier once the ball is rolling.

### How to Make the Invention

The first step in the process is to get the info from each party of the talent and the talent representation. Then they answer all questions in format of who they are, or what they are looking for. Then an algorithm matches each answer with the corresponding one.

Talent:

I am a white male

5′11

155

Brown hair

Brown eyes

Looking for an agent

submit

Talent Representation:

I am looking for

White male

5′11

155

Brown hair

Brown eyes

I am an agent

submit

The necessary questions for this to work are as basic as your name, ethnicity, height, weight, gender and age, submitted with your head shot and resume.

Every other option is optional but likelihood of being selected increases with the number of characteristics entered into the system.

This is where the scale rating will come into play, along with other updates that will be injected at later dates upon the app's release.

There will be a scale rating that only, agents, managers, casting directors and sign me app admins will be able to incur to each talent if they desired that will cost a premium if performed by the sign me admin. a star rating from 1-5 1 being low skills and performance to 5 being highly skilled and recommended works a lot.

### How to Use the Invention

Sign Me is a matched system compatibility app, that will help actors and models seeking representation find a suitable talent representation, through filters, they currently do everything one at a time, sign me does it all at once. It takes the guessing required from all parties involved.

Purpose

SignMe's mission is to bring together Actors seeking Representation and Agents seeking Talent, with specific traits and abilities, through an easy-to-use, cutting edge App that makes it easy to sort and choose Actors meeting those criteria.

SignMe provides a forum for Actors and Agents to find each other

Actors need Representation

Agents need Talent

Actors and Agents each sign into their own specialized portal

Actors enter their vitals and skills

Agents enter search criteria to find the best fit for their casting needs

For Actors. Actors—Verification: Get verified through secure sign-in

Actors—Basic Information. Starts with Basic Information: Stage Name, Appearing Age, Actual Age, Union Status, Ethnicity

Actors—Details. Actors provide more detail to find a customized match: Credits, Training, Skills, Up to 3 can be added, Agent Ready ? Scene, Reel, Monologue, Currently Signed? Commercial, Theatrical, Resume Quality, Good, Fair, Poor.

Actors—More Specifics. Height, Weight, Waist Size, Hair Color, Hair Length, Eye Color, Facial Hair, Build, Body Type, Gender, Appearing Age, Actual Age (DOB), Union Status, Ethnicity, Location, Skills.

Actors—Uploads. Uploads: Multiple Headshots, Add Resume, Edit Resume

Actors—Payments. After uploading a photo and resume, Actors will get a message saying there are X number of potential Agent matches. In order to view those matches, the Actor will need to subscribe. Payments to be made by MC/Visa.

Actors—Cost. Actors can input their information at no cost. In order to obtain details of matches to Agents, Actors subscribe at $2.99 at sign-up and $.99 per month thereafter or they can pay $14.99 up front. Matches are provided to Actors indicating Agencies that are actively searching for Actors with their demographics. The App will provide touch-button to submit resume and headshot to matched Agents.

For agents

Agents—How This Helps. SignMe provides a convenient, easy-to-use, database of potential talent.

Similar to conventional dating apps, SignMe allows Agents to search for the criteria they are looking for.

Displays results based on the % match—the higher the %, the more closely the Actor meets the desired criteria.

Provides the Agents to save “Favorites” and to categorize them based on their casting needs.

Agents—Verification. Agents enter basic information: Agency Name, License Number, Agency Password, Agent Name, Agent Password.

Agents—Choosing Criteria: Height, Weight, Waist Size, Hair Color, Hair Length, Eye Color, Facial Hair, Build, Body Type, Gender Appearing Age, Actual Age (DOB), Union Status, Ethnicity, Location, Skills.

Agents—Additional Criteria.

Agents choose more detail to find a customized match: Credits, Training, Skills, Up to 3 can be added, Agent Ready? Scene, Reel, Monologue, Currently Signed? Commercial, Theatrical, Resume Quality, Good, Fair, Poor.

1. A method for matching talents with prospective talent representatives, said method embodied in computer program code for executing on a plurality of computing devices, each of said plurality of devices having a processor for executing said program code, a memory for storing said program code and input and output data during said executing of said program code, communication capabilities for enabling said device to remotely communicate with other computing devices, and a user interface for enabling a user to input data into the device and access information both locally on the device and remotely on other devices and database servers, said method comprising the steps of:
entering a plurality of physical attributes of a talent user;
entering a plurality of skills attributes of said talent user;
uploading a resume and a photograph of said talent user;
submitting payment through said user interface;
entering a plurality of questions related to filling a talent role;
entering a plurality of search criteria by a talent representative; and
matching said talent user with at least one of a plurality of said talent representative by searching said plurality of physical attributes, said plurality of skills attributes against a plurality of said questions related to said user talent role.

2. The method of claim 1, wherein the step of submitting further comprises selecting from a plurality of casting directors.

3. The method of claim 1, wherein the step of submitting further comprises obtaining a rating from at least one talent representative for grading said talent user's level of experience for each job.
